(19) United States
(12) Patent Application Publication
(10) Pub. No.: US 2021/0394464 A1
(43) Pub. Date: Dec. 23, 2021

(54) A METHOD AND A SYSTEM FOR MANUFACTURING A FIBER COMPOSITE COMPONENT OF A WIND ENERGY INSTALLATION

(71) Applicant: Siemens Gamesa Renewable Energy Service GmbH, Hamburg (DE)

(72) Inventor: Urs Bendel, Fockbek (DE)

(21) Appl. No.: 17/292,322

(22) PCT Filed: Oct. 23, 2019
(86) PCT No.: PCT/EP2019/078781

§ 371 Date: May 7, 2021

(30) Foreign Application Priority Data
Nov. 7, 2018 (DE) 10 2018 008 739.6

(51) Int. Cl. B29C 70/54

(52) U.S. Cl. CPC B29C 70/54; B29L 2031/085

(57) ABSTRACT

A method for manufacturing a fiber composite component of a wind energy installation, in particular a fiber composite rotor blade, includes steps of providing at least one manufactured fiber-containing semi-finished product, and manufacturing the fiber composite component using this semi-finished product which has been provided. The method may further include inspecting, with the aid of a sensor arrangement which includes at least one sensor, the semi-finished product between its manufacture and its use in the course of the manufacture of the fiber composite component, and triggering a fault response if, during the course of the inspection, it is determined that the semi-finished product does not satisfy a predetermined inspection criterion.

### CROSS-REFERENCE TO RELATED APPLICATIONS

This application is a national phase application under 35 U.S.C. § 371 of International Patent Application No. PCT/EP2019/078781, filed Oct. 23, 2019 (pending), which claims the benefit of priority to German Patent Application No. DE 10 2018 008 739.6, filed Nov. 7, 2018, the disclosures of which are incorporated by reference herein in their entirety.

### TECHNICAL FIELD

The present invention relates to a method and a system for manufacturing a fiber composite component of a wind energy installation, in particular a fiber composite rotor blade.

### BACKGROUND

Due to requirements in terms of geometry, mass, mass inertia and strength, rotor blades of wind energy installations are advantageously manufactured from fiber composite materials.

For this, fiber-containing semi-finished products are advantageously used, in particular non-impregnated (“dry”) fiber scrims, pre-impregnated fiber matrix semi-finished products, as well as fiber-reinforced plastic profiles, which are supplied in a prefabricated state.

### SUMMARY

It is an object of the present invention to improve fiber composite components of wind energy installations, in particular fiber composite rotor blades of wind energy installations, and/or their manufacture.

This object is solved by methods and a system for carrying out one of the methods, as described herein.

According to one embodiment of the present invention, a method of manufacturing a fiber composite component of a wind energy installation comprises the steps of:
providing one or more manufactured or pre-manufactured fiber-containing semi-finished products; and
manufacturing the fiber composite component using this semi-finished product or these semi-finished products which has/have been provided.

According to one embodiment, the fiber composite component is a fiber composite rotor blade. The present invention may be used with particular advantage for this purpose, in particular due to the requirements in terms of geometry, mass, mass inertia, strength and safety, without this being intended to be understood as a limitation.

The manufacture of the fiber composite component using the semi-finished product or products comprises, according to one embodiment, a primary forming of the component, during the course of which the semi-finished product or products is/are installed, in particular a primary forming of the component from the semi-finished product or products, according to one embodiment with the aid of a mold, in particular in a mold, and/or a re-forming and/or a separating of the semi-finished product or products, in particular a cutting (to size) of the semi-finished product or products, and/or a curing, in particular a thermal and/or a chemical curing, of a matrix bonding the fibers of the semi-finished product or products, according to one embodiment under negative pressure. Fibers of the semi-finished product or of one or more of the semi-finished products can in particular be glass fibers and/or carbon fibers, and the fiber composite component can, in a corresponding manner, be a GF component or a CF component, in particular. The present invention may be used with particular advantage for this purpose, without this being intended to be understood as a limitation.

According to one embodiment, providing a semi-finished product comprises removing from storage, unpacking, unfolding, (un)stacking, unrolling, laying (out) and/or making up of the semi-finished product.

According to one embodiment of the present invention, the method comprises the steps of:
inspecting, with the aid of a sensor arrangement which comprises one or more sensors, the semi-finished product or one or more of the semi-finished products between (in a temporal sense) its manufacture and its use in the course of the manufacture of the fiber composite component; and
triggering a fault response if, during the course of the inspection, it is determined that the (respective) semi-finished product does not satisfy a predetermined one-dimensional or multidimensional inspection criterion.

According to one embodiment, the likelihood of a failure of the component as a consequence of a defect of the fiber-containing semi-finished product used in the manufacture of the component may be reduced by means of this, and as a result of this, the safety of the wind energy installation may be improved.

According to one embodiment, the manufactured or pre-manufactured semi-finished product is inspected after its manufacture, in particular immediately after its manufacture, and/or (still) prior to a transport or its transport, in particular immediately prior to a transport or its transport, in particular prior to a preparation for transport or its preparation for transport, in particular immediately prior to a preparation for transport or its preparation for transport.

By means of this, according to one embodiment, manufacturing defects can advantageously be detected at an early stage and thus unnecessary transport or unnecessary preparations for transport can be avoided or defects can be corrected at an early stage, if necessary.

According to one embodiment, the preparation for transport can comprise packing, in particular stacking, folding, rolling (up) and/or wrapping in packaging material, and can in particular be packing, in particular stacking, folding, rolling (up) and/or wrapping in packaging material.

In addition or as an alternative, according to one embodiment, the manufactured or pre-manufactured semi-finished product is inspected after a transport or its transport, in particular immediately after a transport or its transport, and/or after a storage or its storage, in particular immediately after a storage or its storage (and prior to its use in the manufacture of the fiber composite component, in particular immediately prior to its use in the manufacture of the fiber composite component).

According to one embodiment, the transport comprises a transport, in particular by truck, rail, or the like, from a manufacturing site or from the production of the (respective) semi-finished product to another building located at a distance, if applicable at a great distance, and the storage comprises in particular the keeping in a building located at a distance, if applicable at a great distance, from the manufacturing site or from the production of the (respective) semi-finished product, in particular at a manufacturing site of the component.

By means of this, according to one embodiment, defects in the (respective) semi-finished product as a consequence of its transport or its storage can advantageously also be detected at an early stage and thus an unnecessary inclusion in the manufacture of the component can be avoided or defects can be corrected at an early stage, if necessary.

In a further development, the manufactured or pre-manufactured semi-finished product is inspected in the course of, or during, unpacking, in particular in the course of, or during, removal of packaging material, in the course of, or during, unstacking and/or in the course of, or during, unrolling, in particular immediately in the course of, or during, unpacking, in particular immediately in the course of, or during, removal of packaging material, immediately in the course of, or during, unstacking and/or immediately in the course of, or during, unrolling.

By means of this, according to one embodiment, defects can advantageously be detected at a particularly early stage.

In addition or as an alternative, in a further development, the manufactured or pre-manufactured semi-finished product is inspected after unpacking or after completion of unpacking, in particular after removal of packaging material or after completion of removal of packaging material, after unstacking or after completion of unstacking and/or after unrolling or after completion of unrolling, in particular immediately after unpacking or immediately after completion of unpacking, in particular immediately after removal of packaging material or immediately after completion of removal of packaging material, immediately after unstacking or immediately after completion of unstacking and/or immediately after unrolling or immediately after completion of unrolling.

By means of this, according to one embodiment, the inspection can be improved, in particular simplified, and/or its reliability can be increased.

In addition or as an alternative, in a further development, the manufactured or pre-manufactured semi-finished product is inspected in the course of, or during, making up of the manufactured or pre-manufactured semi-finished product, in an embodiment in the course of, or during, laying (out) and/or separating of the manufactured or pre-manufactured semi-finished product, in particular in the course of, or during, cutting (to size) of the manufactured or pre-manufactured semi-finished product, in particular immediately in the course of, or during, making up of the manufactured or pre-manufactured semi-finished product, in an embodiment immediately in the course of, or during, laying (out) and/or separating of the manufactured or pre-manufactured semi-finished product, in particular immediately in the course of, or during, cutting (to size) of the manufactured or pre-manufactured semi-finished product, for use in the manufacture of the fiber composite component.

In addition or as an alternative, in a further development, the manufactured or pre-manufactured semi-finished product is inspected prior to making up of the manufactured or pre-manufactured semi-finished product, in an embodiment prior to laying (out) and/or separating of the manufactured or pre-manufactured semi-finished product, in particular prior to cutting (to size) of the manufactured or pre-manufactured semi-finished product, in particular immediately prior to making up of the manufactured or pre-manufactured semi-finished product, in an embodiment immediately prior to laying (out) and/or separating of the manufactured or pre-manufactured semi-finished product, in particular immediately prior to cutting (to size) of the manufactured or pre-manufactured semi-finished product, for use in the manufacture of the fiber composite component.

In addition or as an alternative, in a further development, the manufactured or pre-manufactured semi-finished product is inspected after making up of the manufactured or pre-manufactured semi-finished product, in an embodiment after laying (out) and/or separating of the manufactured or pre-manufactured semi-finished product, in particular after cutting (to size) of the manufactured or pre-manufactured semi-finished product, in particular immediately after making up of the manufactured or pre-manufactured semi-finished product, in an embodiment immediately after laying (out) and/or separating of the manufactured or pre-manufactured semi-finished product, in particular immediately after cutting (to size) of the manufactured or pre-manufactured semi-finished product, for use in the manufacture of the fiber composite component.

By carrying out the inspection prior to, and/or during the course of, making up of the semi-finished product for use in the manufacture of the fiber composite component, according to one embodiment, defects can, in an advantageous manner, be detected early or earlier and thus (further) making up or unnecessary inclusion in the manufacture of the component can be avoided and/or the inspection can be improved, in particular simplified, and/or its reliability can be increased, and, according to one embodiment, by carrying out an inspection during the course of, and/or after, making up of the semi-finished product, in an advantageous manner, defects caused by the making up of the semi-finished product can also be detected and/or the inspection can be improved, in particular simplified, and/or its reliability can be increased, in particular if the semi-finished product is reduced in size by means of the making up of the semi-finished product and thus becomes more manageable.

According to one embodiment, the manufactured or pre-manufactured semi-finished product or one or more of the manufactured or pre-manufactured semi-finished products are inspected, with the aid of the sensor arrangement in a non-contact manner, optically, according to one embodiment by means of one or more cameras, radiologically or by means of X-rays, electrically, according to one embodiment capacitively and/or inductively, thermally, according to one embodiment by means of thermography, and/or acoustically, according to one embodiment by means of ultrasound, in particular individually, according to one embodiment in a successive or a sequential manner, or jointly, according to one embodiment in a parallel manner.

According to one embodiment, by carrying out the inspection in a non-contact manner, a disturbing of the process can advantageously be avoided and/or the inspection can be integrated into the process of using the semi-finished product in the manufacture of the component and thus a processing time can be shortened.

According to one embodiment, in an advantageous manner, by carrying out an inspection of two or more semi-finished products together, a processing time can be shortened (further), and by carrying out the inspection on an individual basis, a more compact sensor arrangement can be used.

According to one embodiment, by the carrying out of an optical inspection, semi-finished products can be inspected in an advantageous manner, in particular in a simple manner, a variable manner and/or in a reliable manner. According to one embodiment, by the carrying out of a radiological, electrical, thermal and/or acoustic inspection, defects that are not able to be detected visually can also be detected in an advantageous manner.

According to one embodiment, one or more images, in particular one or more radiological images, thermographic images, photographic images and/or ultrasound images, of the semi-finished product or products are recorded and, in a further development, are evaluated with the aid of image processing (for checking the inspection criterion or criteria or for carrying out a check in relation to the inspection criterion or criteria).

By means of this, according to one embodiment, a processing time can be shortened (further) and/or more complex defects can be detected.

Accordingly, the sensor or one or more of the sensors of the sensor arrangement each comprise at least one photographic camera, according to one embodiment a digital camera, in particular a CCD camera or the like, at least one thermal camera or thermal image camera, at least one ultrasonic sensor and/or at least one X-ray sensor.

According to one embodiment, the sensor or one or more of the sensors of the sensor arrangement are moved relative to the manufactured semi-finished product, according to one embodiment in a motor-driven manner and/or transversely to a conveying direction of the (respective) semi-finished product, for the purpose of carrying out the inspection, in particular during the course of the inspection, in particular for the purpose of recording the image or images, in particular during the course of the recording of the image or images.

By means of this, according to one embodiment, compact sensors or more compact sensors and/or sensors with a fine resolution or sensors with a finer resolution can be used and/or larger semi-finished products or larger areas of semi-finished products can be inspected in an advantageous manner.

According to one embodiment, at least two surfaces, in particular two opposite surfaces, of the manufactured semi-finished product or of each of the manufactured semi-finished products are inspected, according to one embodiment jointly, in particular (temporally and/or spatially) in parallel, and/or by at least two sensors of the sensor arrangement, which, according to one embodiment, are moved for this purpose in a motor-driven manner, in particular in the same direction or in opposite directions, and/or which are arranged on opposite sides of the semi-finished product or products.

By means of this, according to one embodiment, a processing time can be shortened (further) and/or more defects can be detected.

According to one embodiment, the inspection criterion depends on a number and/or orientation of fibers, in particular a number and/or orientation of rovings, and/or on a matrix of the manufactured semi-finished product in which these are embedded. In a further development, a semi-finished product does not satisfy the inspection criterion if (it is detected that) a number of its fibers, in particular a number of its rovings, are outside a predetermined range, or if a predetermined minimum number of its fibers, in particular a predetermined minimum number of its rovings, deviate more from a predetermined orientation than is permitted, in particular if a predetermined minimum number of its fibers, in particular a predetermined minimum number of its rovings, are (excessively) undulated or wavy, or if a predetermined minimum number of its fibers, in particular a predetermined minimum number of its rovings, are insufficiently impregnated or insufficiently bonded to one another, or the like.

By means of this, according to one embodiment, the probability of a failure of the component occurring as a result of a defect in the fiber-containing semi-finished product used in the manufacture of the component can be reduced (further), and thereby the safety of the wind energy installation can be improved (further).

According to one embodiment, the inspection criterion is learned by machine learning, in a further development it is learned by machine learning, or continues to be learned by machine learning, during the inspection, according to one embodiment with the aid of an artificial neural network or the like.

By means of this, according to one embodiment, different (types of) semi-finished products can advantageously be inspected, advantageous sensors can be used, and/or a speed and/or a reliability of the inspection can be improved.

According to one embodiment, the fault response comprises a message, according to one embodiment a visual message and/or an audible message.

In addition or as an alternative, according to one embodiment, the fault response comprises an intervention in a manufacturing process, in particular a direct and/or automatic intervention in a manufacturing process, according to one embodiment a stopping of at least one manufacturing device.

By means of this, according to one embodiment, the respective semi-finished product can be manually reinspected and/or manually reworked or (if necessary) rejected or replaced.

Such rejecting, replacing and/or reworking of the manufactured semi-finished product can, according to one embodiment, also take place in an automated manner.

By means of a manual or automated rejecting, replacing and/or reworking, according to one embodiment, the probability of a failure of the component occurring as a result of a defect of in the fiber-containing semi-finished product used in the manufacture of the component can be reduced (further), and thereby the safety of the wind energy installation can be improved (further).

In addition or as an alternative, according to one embodiment, the fault response comprises storing an inspection result, in particular a quantitative deviation from the predetermined inspection criterion, a fault class or a fault classification, and/or at least one image of the semi-finished product.

In addition or as an alternative, according to one embodiment, a result of the inspection and/or one or more images used during the course of the inspection, in particular one or more images recorded during the course of the inspection (“image or images of the inspection”), are stored, according to one embodiment at least until the fiber composite component has been manufactured, in a further development beyond that.

By means of this, according to one embodiment, the inspection can advantageously be documented and, if applicable, be used for a statistical evaluation, for the machine learning, for a failure analysis or the like.

The present invention is particularly suitable for dry fiber scrims or fiber scrims which are (still) without a matrix, in particular dry woven fiber fabrics, pre-impregnated fiber matrix semi-finished products, in particular with thermosetting matrices and/or partially crosslinked matrices, in particular reactive resins, pre-impregnated, uncured fiber matrix semi-finished products, which, according to one embodiment, are cured under temperature and/or pressure for the purpose of manufacturing the component, in particular prepregs (“pre-impregnated fibers”), BMCs (“bulk molding compounds”) or SMCs (“sheet molding compounds”), as well as fiber-reinforced profiles, in particular pultruded fiber-reinforced profiles, in particular plastic profiles.

According to one embodiment of the present invention, a system is set up, in particular in terms of hardware and/or software, in particular in terms of programming, for carrying out a method described herein, and/or comprises:
means for inspecting, with the aid of a sensor arrangement which comprises one or more sensors, one or more fiber-containing semi-finished products which has/have been provided, between its or their manufacture and its or their use in the course of the manufacture of the fiber composite component; and
triggering a fault response if, during the course of the inspection, it is determined that the (respective) semi-finished product does not to satisfy a predetermined inspection criterion.

According to one embodiment, the system, or its means, comprises:
means for providing the manufactured or pre-manufactured fiber-containing semi-finished product or products; and/or
means for manufacturing the fiber composite component using this semi-finished product or these semi-finished products which has/have been provided.

According to one embodiment, the system, or its means, comprises:
means for inspecting, with the aid of the sensor arrangement, the semi-finished product after its manufacture, in particular immediately after its manufacture, and/or prior to a transport, in particular immediately prior to a transport, in particular prior to a preparation for transport, in particular immediately prior to a preparation for transport, and/or after a transport, in particular immediately after a transport, and/or after a storage, in particular immediately after a storage, in particular in the course of unpacking, in particular immediately in the course of unpacking, and/or after an unpacking, in particular immediately after an unpacking, and/or during the course of a making up, in particular immediately during the course of a making up, and/or prior to a making up, in particular immediately prior to a making up, and/or after a making up, in particular immediately after a making up, for use in the manufacture of the fiber composite component;
means for inspecting the semi-finished product with the aid of the sensor arrangement in a non-contact manner, optically, in particular by means of at least one camera, radiologically, electrically, thermally, in particular by means of thermography, and/or acoustically, in particular by means of ultrasound;
means for recording at least one image of the manufactured semi-finished product, in particular for the purpose of evaluation with the aid of image processing, for the purpose of inspection;
means for moving at least one sensor of the sensor arrangement relative to the manufactured semi-finished product, in particular in a motor-driven manner and/or transversely to a conveying direction of the semi-finished product, for the purpose of inspection;
means for inspecting at least two surfaces, in particular two opposite surfaces, of the manufactured semi-finished product, in particular jointly and/or by at least two sensors of the sensor arrangement;
means, in particular an artificial neural network, for implementing the inspection criterion learned by machine learning, in particular for learning the inspection criterion by machine-learning;
means for reporting and/or storing an inspection result, in particular for visually and/or acoustically reporting and/or storing an inspection result, and/or means for rejecting, replacing and/or reworking of the manufactured semi-finished product; and/or
means for storing a result of the inspection and/or at least one image of the inspection, in particular at least until the fiber composite component has been manufactured, or beyond that.

A means in the sense of the present invention can be constructed in terms of hardware and/or software, and may comprise in particular a processing unit, in particular a microprocessor unit (CPU) or a graphics card (GPU), in particular a digital processing unit, in particular a digital microprocessor unit (CPU), a digital graphics card (GPU) or the like, preferably connected to a memory system and/or a bus system in terms of data or signal communication, and/or may comprise one or more programs or program modules. The processing unit may be constructed so as to process instructions which are implemented as a program stored in a memory system, to acquire input signals from a data bus, and/or to output output signals to a data bus. A memory system may comprise one or more storage media, in particular different storage media, in particular optical media, magnetic media, solid state media and/or other non-volatile media. The program may be of such nature that it embodies the methods described herein, or is capable of executing them, such that the processing unit can execute the steps of such methods and thereby in particular manufacture the fiber composite component or inspect the semi-finished product.

According to one embodiment, one or more steps of the method, in particular all steps of the method, are carried out in a fully or partially automated manner, in particular by the system or its means.

Further advantages and features will become apparent from the claims and the example embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIGS. 1-3 respectively schematically illustrate a system or steps of a method for manufacturing a fiber composite rotor blade of a wind energy installation in accordance with an embodiment of the present disclosure; and

FIG. 4 is a flowchart illustrating the method of FIGS. 1-3.

### DETAILED DESCRIPTION

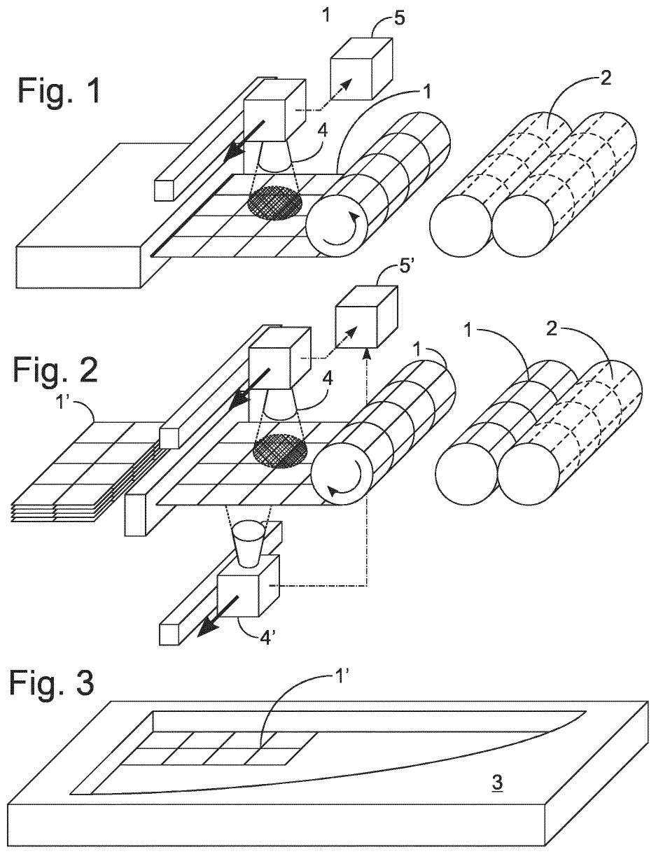

FIGS. 1 to 3 respectively show a system or steps of a method for manufacturing a fiber composite rotor blade of a wind energy installation according to an embodiment of the present invention.

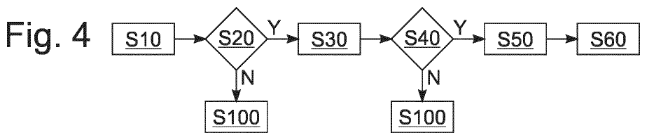

As indicated in FIG. 1, fiber-containing semi-finished products, which, by way of example, are dry fiber scrims or prepregs 1 in the example embodiment, are manufactured (FIG. 4: S10) and, after their manufacture, are prepared for transport by being rolled up and wrapped in packaging material 2 (FIG. 4: S30).

These semi-finished products 1, which have been manufactured and prepared for transport, are transported to a manufacturing facility for rotor blades, are stored there and, as indicated in FIG. 2, are unpacked (FIG. 4: S30) and are made up for use in the manufacture of the rotor blades (FIG. 2: 1→1′; FIG. 4: S50).

The rotor blades are then manufactured using this made-up fiber scrim or prepreg 1′, as indicated in FIG. 3 by a mold for a rotor blade 3 (FIG. 4: S60).

As indicated in FIG. 1, according to one embodiment, the semi-finished products are inspected, after their manufacture and prior to being prepared for transport, with the aid of a sensor arrangement (FIG. 4: S20), whereby only one camera 4 is indicated in FIG. 1 by way of example, which camera 4 is moved transversely to the conveying direction of the semi-finished products 1 in a motor-driven manner.

In addition or as an alternative, according to one embodiment, as indicated in FIG. 2, the semi-finished products are inspected, with the aid of a sensor arrangement (FIG. 4: S40), after transport, storage and unpacking and prior to being made up, whereby two cameras 4, 4′ which are situated opposite to one another are indicated in FIG. 2, which cameras 4, 4′ are moved transversely to the conveying direction of the semi-finished products in a motor-driven manner.

An artificial neural network 5 or 5′ processes images recorded by the cameras and inspects these as regards an inspection criterion learned by machine learning, which inspection criterion comprises, for example, permissible maximum numbers of missing rovings or an undulation of rovings, permissible impregnation defects or the like.

If it is determined during the course of the inspection that a semi-finished product does not satisfy the inspection criterion specified in this way (S20: “N”, or S40: “N”), the neural network triggers an error message so that the corresponding semi-finished product can be rejected, replaced or reworked (FIG. 4: S100); otherwise, or if the inspected semi-finished product satisfies the inspection criterion (S20: “Y”, or S40: “Y”), it can be used in the manufacture of a rotor blade.

Although example embodiments have been explained in the preceding description, it is to be noted that a large number of variations are possible.

For example, both an inspection at the manufacturing site of the semi-finished products and also at the manufacturing site of the rotor blades, which may be in a different building, has been explained herein, whereby it is also possible that an inspection is only provided at the manufacturing site of the semi-finished products or immediately after their manufacture or prior to their being prepared for transport or however only an inspection at the manufacturing site of the rotor blades or during the course of, or after, an unpacking and prior to a making up. In addition or as an alternative, the inspection may also take place during the course of the unpacking and/or during the course of, and/or after, the making up.

It is also to be noted that the example embodiments are merely examples which are not intended to limit the scope of protection, the applications and the structure in any way. Rather, the preceding description provides the skilled person with a guideline for the implementation of at least one example embodiment, whereby various modifications, in particular with regard to the function and the arrangement of the components described, can be made without departing from the scope of protection as it results from the claims and from combinations of features equivalent to these.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 semi-finished product prior to being prepared for transport
1′ semi-finished product after making up
2 packaging material
3 mold for manufacture of rotor blade
4, 4′ camera
5, 5′ artificial neural network

What is claimed is:

1-11. (canceled)

12. A method for manufacturing a fiber composite component of a wind energy installation, the method comprising:
obtaining at least one manufactured, fiber-containing, semi-finished product;
manufacturing the fiber composite component using the semi-finished product;
inspecting, with the aid of a sensor arrangement that comprises at least one sensor, the semi-finished product between its manufacture and its use in the course of the manufacture of the fiber composite component; and
triggering a fault response in response to a determination that the semi-finished product does not satisfy at least one predetermined criterion, wherein the predetermined criterion is evaluated based on a result obtained from the sensor arrangement.

13. The method of claim 12, wherein the manufactured fiber composite component is a fiber composite rotor blade.

14. The method of claim 12, wherein inspecting the manufactured semi-finished product with the aid of the sensor arrangement comprises at least one of:
inspecting the semi-finished product after its manufacture;
inspecting the semi-finished product prior to a transport of the semi-finished product;
inspecting the semi-finished product after a transport of the semi-finished product;
inspecting the semi-finished product after a storage of the semi-finished product;
inspecting the semi-finished product during an unpacking of the semi-finished product;
inspecting the semi-finished product after an unpacking of the semi-finished product;
inspecting the semi-finished product during the course of a making up for use in the manufacture of the fiber composite component;
inspecting the semi-finished product prior to a making up for use in the manufacture of the fiber composite component; or
inspecting the semi-finished product after a making up for use in the manufacture of the fiber composite component.

15. The method of claim 14, wherein at least one of:
inspecting the semi-finished product after its manufacture comprises inspecting immediately after its manufacture;
inspecting prior to a transport comprises at least one of inspecting immediately prior to a transport, inspecting prior to a preparation for transport, or inspecting immediately prior to a preparation for transport;
inspecting after a transport comprises inspecting immediately after a transport;
inspecting after a storage comprises at least one of inspecting immediately after a storage, inspecting in the course of or after unpacking, or inspecting immediately in the course of or after unpacking;
inspecting after an unpacking comprises inspecting immediately after an unpacking;
inspecting during the course of a making up comprises inspecting immediately during the course of a making up;
inspecting prior to a making up comprises inspecting immediately prior to a making up; or inspecting after a making up comprises inspecting immediately after a making up.

16. The method of claim 12, wherein:
inspecting the manufactured semi-finished product with the aid of the sensor arrangement comprises inspecting at least one of:
in a non-contact manner,
optically,
radiologically,
electrically,
thermally, or
acoustically; or
inspecting the manufactured semi-finished product further comprises:
recording at least one image of the manufactured semi-finished product.

17. The method of claim 16, wherein at least one of:
inspecting optically comprises inspecting with at least one camera;
inspecting thermally comprises inspecting using thermography;
inspecting acoustically comprises inspecting using ultrasound; or
inspecting by recording at least one image of the manufactured semi-finished product further comprises evaluating the at least one image with the aid of image processing.

18. The method of claim 1, wherein inspecting the semi-finished product further comprises moving at least one sensor of the sensor arrangement relative to the manufactured semi-finished product.

19. The method of claim 18, wherein moving at least one sensor comprises at least one of:
moving the at least one sensor in a motor-driven manner; or
moving the at least one sensor transversely to a conveying direction of the semi-finished product.

20. The method of claim 12, wherein inspecting the semi-finished product comprises inspecting at least two surfaces of the semi-finished product.

21. The method of claim 20, wherein inspecting at least two surfaces of the semi-finished product comprises at least one of:
inspecting two opposite surfaces of the manufactured semi-finished product;
jointly inspecting the at least two surfaces of the semi-finished product; or
inspecting the at least two surfaces of the semi-finished product using at least two sensors of the sensor arrangement.

22. The method according of claim 12, wherein the criterion depends on at least one of:
a number of fibers;
an orientation of fibers;
at least one of a number or orientation of rovings; or
a matrix of the manufactured semi-finished product in which the fibers or rovings are embedded.

23. The method of claim 12, wherein at least one of:
the criterion is learned by machine learning; or
machine-learned criteria continues to be learned by machine learning during the inspection.

24. The method of claim 12, wherein triggering the fault response comprises at least one of:
triggering a message;
triggering an intervention in a manufacturing process;
storing an inspection result; or
at least one of rejecting, replacing, or reworking the manufactured semi-finished product.

25. The method of claim 24, wherein triggering a message comprises triggering at least one of a visual message or an audible message.

26. The method of claim 12, further comprising storing at least one of a result of the inspection or at least one image of the inspection.

27. The method of claim 26, wherein the stored result or image is stored at least until the fiber composite component is manufactured.

28. The method of claim 26, wherein the stored result or image is stored beyond when the fiber composite component is manufactured.

29. The method of claim 12, wherein the manufactured semi-finished product comprises at least one of:
a dry fiber scrim;
a pre-impregnated fiber matrix semi-finished product; or
a fiber-reinforced profile.

30. The method of claim 29, wherein at least one of:
the dry fiber scrim comprises a dry woven fiber fabric; or
the fiber-reinforced profile is at least one of a pultruded fiber-reinforced profile or a plastic profile.

31. A system for manufacturing a fiber composite component of a wind energy installation, in particular a fiber composite rotor blade, comprising:
means for inspecting, with the aid of a sensor arrangement that comprises at least one sensor, a fiber-containing semi-finished product, wherein the inspection occurs between a manufacture of the semi-finished product and a use of the semi-finished product in a manufacture of the fiber composite component; and
means for triggering a fault response during the course of inspection in response to a determination that the semi-finished product does not satisfy at least one predetermined criterion.
